(19) United States
(12) Patent Application Publication
(10) Pub. No.: US 2006/0288823 A1
(43) Pub. Date: Dec. 28, 2006

(54) Ratcheting hand tools particularly suited to bicycle assembly, maintenance and repair

(76) Inventor: Michael Schepman, Ann Arbor, MI (US)

Correspondence Address: John G. Posa;Gifford, Krass, Groh, Sprinkle,, Anderson & Citkowski, P.C., PO Box 7021, Troy, MI, 48007-7021, US

(21) Appl. No.: 11/444,561

(22) Filed: Jun. 1, 2006

Related U.S. Application Data
(60) Provisional application No. 60/686,659, filed on Jun. 1, 2005.

(51) Int. Cl. B25B 13/46; B25G 1/00

(52) U.S. Cl. 81/60; 81/177.5

(57) ABSTRACT

Hand tools feature a ratcheting driver implement having opposing ends, one to tighten, and the other to loosen. A non-ratcheting implement of the same size may be provided resulting in a T-handle configuration. The driver implement may be a hex or “Allen” wrench, though other tools such as slot/Phillips screwdrivers, hex sockets and Torx implements, in any size, English or metric, may alternatively be accommodated.

### REFERENCE TO RELATED APPLICATION

This application claims priority to U.S. Provisional Patent Application Ser. No. 60/686,659, filed Jun. 1, 2005, the entire content of which is incorporated herein by reference.

### FIELD OF THE INVENTION

This invention relates generally to hand tools and, in particular, to ratcheting tools particularly suited to bicycle assembly, maintenance and repair.

### BACKGROUND OF THE INVENTION

T-handled hex wrenches are available from multiple sources. Such tools typically come in sets, and feature a relatively long wrench with a ball drive to reach off-axis components and a shorter, regular shaft for more easily reached parts. The handle may often be more L-shaped. Although these tools are comfortable and effective, they could be more versatile.

### SUMMARY OF THE INVENTION

This invention resides in hand tools that feature a ratcheting driver implement having opposing ends, one to tighten, and the other to loosen. In the preferred embodiment, the ratcheting driver implement is provided with a non-ratcheting implement of the same size forming a T-handle. The driver implement may be a hex or “Allen” wrench, though one of skill in the art will appreciate that other tools such as slot/Phillips screwdrivers, hex sockets and Torx implements, in any size, English or metric, may alternatively be accommodated.

### BRIEF DESCRIPTION OF THE DRAWINGS

FIG. 1 is a side-view drawing in partial cross section illustrating a preferred embodiment of the invention;

FIG. 2 is a sectional view of the embodiment depicted in FIG. 1;

FIG. 3 is an exploded view drawing showing the way in which a tool according to the invention may be constructed; and

FIG. 4 shows a ratchet with collars and set screws to resist slipping.

### DETAILED DESCRIPTION OF THE INVENTION

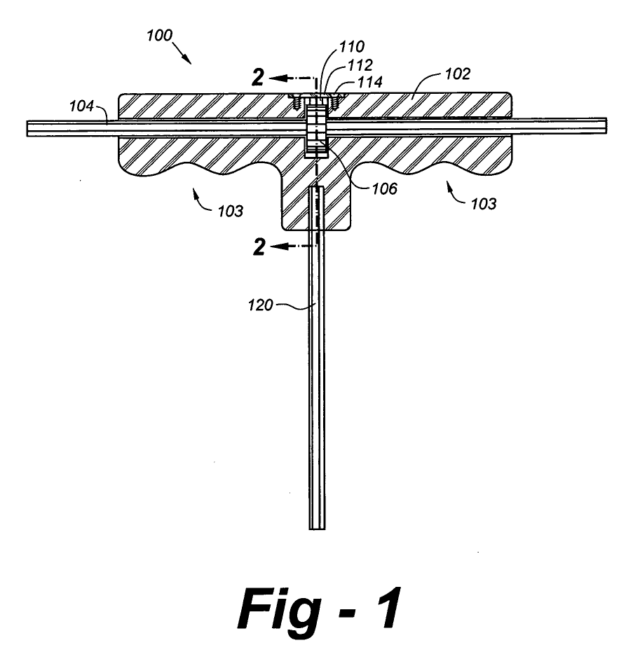

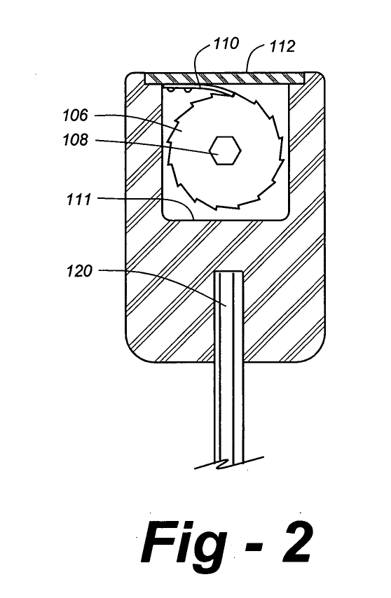

FIG. 1 is a side-view drawing in partial cross section illustrating a preferred embodiment of the invention depicted generally at 100. The tool features a T-shaped handle 102 with optional, finger-receiving ergonomic curves 103. The handle is preferably constructed of molded plastic with an optional outer compressible/resilient coating.

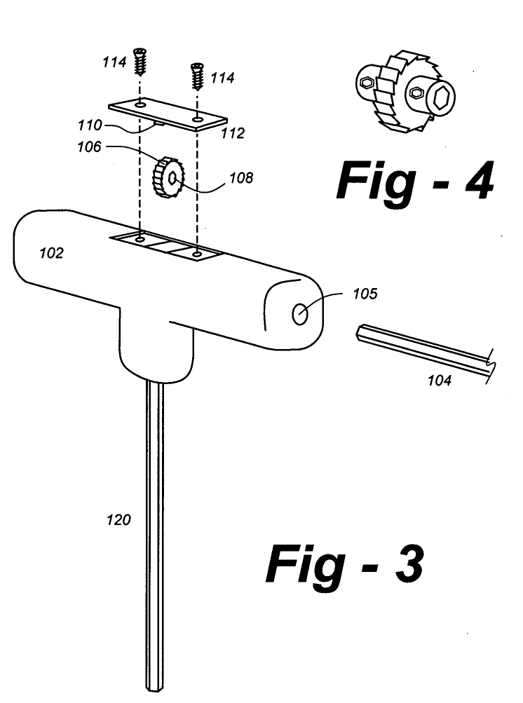

Running lengthwise through the upper “T” portion of the handle is a driver implement 104 which, in the case of FIG. 1, is a hex driver. The implement runs through a central ratchet wheel 106, the unidirectional rotation of which is controlled by pawl 110. Pawl 110 is preferably attached to a plate 112 held in position with screws 114. Pawl 110 is preferably a piece of spring steel. As an alternate to mounting on plate 112, the pawl may be located on the bottom of the central well against surface 111. In any case the use of a removable plate such as 112 facilitates easier maintenance and assembly as shown in FIG. 3.

The driver implement 104 may extend out of each end at any appropriate length. Thus the drawings should not be scaled to limit the invention in this regard. The same hold true of fixed implement 120 which extends downwardly from the bottom of the handle. In the preferred embodiment, the geometry of implement 120 is the same as 104, and both are made of hardened steel. Although not shown, the tip of implement 120 may be rounded to accommodate off-axis components.

FIG. 3 shows the way in which a tool according to the invention would be assembled. Ratchet wheel 106 includes a bore 108 which is slightly smaller than the outer dimensions of the implement 104. This allows the wheel to be placed in the central well and held in position with implement 104 being inserted through side hole 105. Once aligned with bore 108, the implement 104 may be tapped through the handle until it protrudes out the opposite end. The wheel may be made of hard plastic or soft metal, allowing for a slight degree of deformation as the implement is tapped through. Following this, the plate 112 with pawl may be assembled to the handle using screws 114. To ensure against slippage along the shaft of the driver implement one or two collars with sets screws may be used, as shown in FIG. 4.

The shape of the tool allows the user to achieve a good mechanical advantage, while the ratcheting device makes the tool easy and convenient to use because it allows the user to tighten or loosen a component by simply turning the handle around. Thus, unlike most tools which utilize a ratcheting mechanism, a switch is not required reverse direction. The tool was primarily designed for use in the areas of bicycle assembly, repair and maintenance. However, other fields of use should benefit, including assembly, repair and maintenance of motorcycles, on- and off-road vehicles, watercraft, aircraft, lawn and garden tools, mowers, small engines, sports equipment and surgical instruments. Tools according to the invention would typically be provided in standard (English) or metric sizes, and would also be available in sets.

I claim:

1. A hand tool, comprising:
a handle having opposing ends and a lengthwise bore;
a driver implement disposed within the bore, the driver implement having first and second ends which extend outwardly past the opposing ends of the handle; and
a ratchet mechanism within the handle, the ratchet mechanism being operative to limit the rotation of the driver implement in one direction, enabling a user to use the first end of the implement to tighten a component and the second end of the implement to loosen the component.

2. The hand tool of claim 1, wherein the first and second ends of the driver implement are English or metric hex wrenches.

3. The hand tool of claim 1, wherein the first and second ends of the driver implement are configured to receive English or metric socket wrenches.

4. The hand tool of claim 1, wherein the first and second ends of the driver implement are screwdrivers.

5. The hand tool of claim 1, wherein the first and second ends of the driver implement are English or metric Torx wrenches.

6. The hand tool of claim 1, wherein:
the handle is T-shaped, having a central bottom portion; and
a physically fixed driver implement extending outwardly from the bottom portion.

7. The hand tool of claim 1, wherein the ratcheting mechanism is accessible through a panel on the handle.
